(19) United States
(12) Patent Application Publication
(10) Pub. No.: US 2004/0249933 A1
(43) Pub. Date: Dec. 9, 2004

(54) Network interface parameters

(76) Inventors: Priva Govindarajan, Hillsboro, OR (US); Patrick L. Connor, Portland, OR (US); Eric K. Mann, Hillsboro, OR (US); Hieu T. Tran, Portland, OR (US); John P. Jacobs, Beaverton, OR (US); David M. Durham, Hillsboro, OR (US); Gary D. Gumanow, Portland, OR (US); Chun Yang Chiu, Beaverton, OR (US); Wayne J. Swick, Keizer, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/455,278

(22) Filed: Jun. 4, 2003

(51) Int. Cl. G06F 15/173; G06F 15/16

(52) U.S. Cl. 709/224; 709/250

(57) ABSTRACT

In general, in one aspect, the disclosure describes a method that includes automatically applying different sets of parameter values to a network interface component, storing performance data for the network interface component for the different sets of parameter values, and selecting a one of the different sets of parameters values based on the performance data.

### BACKGROUND

Computers and other devices connect to networks via network interface components. For example, many computer systems feature a network interface card (NIC) that acts as an intermediary between a communication medium, such as a network cable, and other system components. Generally, a NIC includes a physical layer (PHY) component that converts between the physical signals (e.g., wire voltages) of the communication medium and the “1”-s and “0”-s used by digital devices. The NIC may also perform other operations. For example, the NIC may include logic to identify logical groupings of bits known as protocol data units (PDUs). For instance, a NIC may identify a logical group of bits known as a “frame”. A frame usually includes bits that identify the start and end of the frame and data used to verify correct transmission of the frame. A frame may encapsulate other PDUs such as datagrams, packets, or cells. Potentially, the NIC may extract (“de-encapsulate”) these other PDUs from within the frame.

After receiving data, a NIC may notify other system components of the data's arrival. For example, the NIC may transfer received data to memory accessible to a host processor and alert the host processor to the data by generating an interrupt signal.

Many network interface components may be configured by the settings of different parameters. For example, some parameters may control how often a NIC issues an interrupt signal. A high value can cause the NIC to accumulate several PDUs before sending an interrupt while a low value may cause the NIC to send an interrupt after each protocol data unit arrives. Thus, the setting represents a tradeoff between conserving processor resources by issuing fewer interrupts and increasing the speed of PDU processing by issuing interrupts more frequently.

A wide variety of other parameters can affect NIC operation. For example, parameters can control memory resources used by the NIC. For instance, parameters may control the amount of memory allocated to the NIC to hold received PDUs. While a high parameter value may prevent the NIC from running low on memory resources, a high value increases the memory resources consumed.

### BRIEF DESCRIPTION OF THE DRAWINGS

FIG. 1 is a diagram of a system including a network interface component.

FIG. 2 is a flowchart of a process to determine parameter settings for different network traffic.

FIG. 3 is a flowchart of a process to apply parameters to a network interface component.

### DETAILED DESCRIPTION

Parameter settings can greatly affect the performance of a network interface component. For example, parameter settings may affect throughput of the component and/or the load placed on processor resources (e.g. processor utilization and memory).

The performance provided by a given set of settings, however, may vary depending on a variety of factors. For example, network interface component parameters will have a different impact on performance depending on the network traffic handled by the network interface. For example, a File Transfer Protocol (FTP) server transmitting a large file will generally be transmitting a large number of larger PDUs. Thus, the network interface component of an FTP server would likely benefit from a large allocation of transmit resources. Since the timing of file transfer is of lesser importance, interrupts can be heavily moderated. An audio streaming server, however, will transmit many small, time-sensitive PDUs. Thus, an audio streaming server may benefit from increasing processor interrupts. In this example, parameter settings suited for one kind of traffic may result in poor performance for the other and vice versa.

In addition to different network traffic, parameter settings may have a different performance impact in different system environments. For example, systems may vary in terms of their memory architectures, processor speeds, buses, operating systems, available memory, and so forth.

The oftentimes unpredictable interaction between different parameters further complicate the task of determining suitable parameter values. Thus, a painstaking theoretical development of a set of parameter values for a given environment may sometimes provide performance that could be improved upon.

This disclosure describes techniques that automatically tune network interface component parameter settings. To determine settings, logic automatically tests different sets of parameter values and measures the resulting performance. The testing can explore a wide variety of parameter setting combinations. A particular set of parameter values may be selected from those tested by comparing the performance to specified criteria. Automatic exploration of “parameter-space” can often identify parameter settings that offer better performance than settings derived from theoretical predictions.

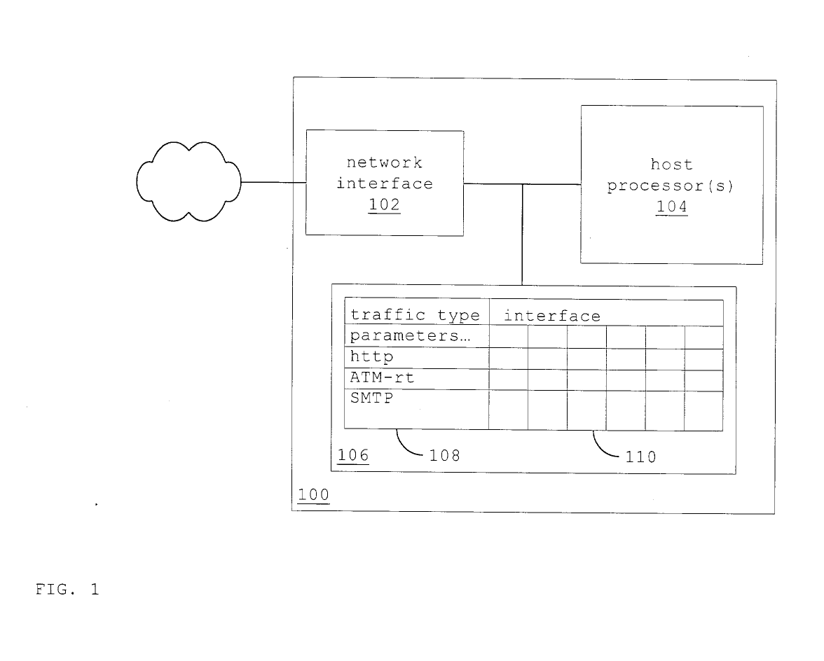

To illustrate, FIG. 1 depicts a system 100 that includes a network interface card 102 (a.k.a. a network adapter) that provides access to a network. The network interface card 102 may feature a physical layer (PHY) component (e.g., a wired, optic, or wireless PHY) that connects the card 102 to a network connection. The network interface card 102 also features an interface to a bus (e.g., a Peripheral Component Interconnect (PCI), PCI Express, Universal Serial Bus (USB) interface, Infiniband, or HyperTransport™ bus) that enables the network interface card 102 to communicate with system 100 components such as host processor(s) 104 or other network components such as a Transmission Control Protocol/Internet Protocol (TCP/IP) Offload Engine (not shown). The network interface card 102 may handle data transfer (e.g., using Direct Memory Access (DMA)) and interrupt signaling with other system 100 components (e.g., host processor(s) 104).

Again, the network interface card 102 can perform a variety of data communication operations such as physical and link layer (e.g., framing) operations. For example, the network interface card 102 may provide operations for processing Synchronous Optical NETwork (SONET) and/or Ethernet frames (e.g., performing error detection, identifying frame boundaries, and so forth).

As shown, FIG. 1 also depicts data 106 that identifies different sets of network interface parameter values 110 associated with different environments. For example, as shown, the data 106 may identify sets of parameter values 110 for different types of network traffic 108. After selection or detection of network traffic, the parameters associated with the traffic may be applied to the network interface component 102.

In the example shown, the different sets of parameters are associated with a traffic type identifier 108. For instance, identifiers 108 may represent traffic of different network communication protocols that operate at different layers in the protocol stack (e.g., the link layer, network layer, application layer, Asynchronous Transfer Mod (ATM) adaptation layer). For example, application layer traffic types may include Hypertext Transfer Protocol (HTTP), Simple Mail Transfer Protocol (SMTP), or File Transfer Protocol (FTP). Instead of identifying a particular protocol or application, the traffic type may identify a generic class of application such as “streaming audio” or “network backup”.

In addition to, or instead of, an identifier, the parameters may be associated with “finer grained” characteristics of the network traffic such as the number and duration of connections (e.g., TCP/IP connections or ATM circuits), PDU size average and distribution, and so forth. Alternately, or in addition, a given tuple (“row”) of parameters may be associated with different system characteristics (e.g., operating system, bus, processor speed, memory, and so forth). Thus, a lookup for the parameter settings to apply may be keyed by one or more traffic and/or system characteristics.

Different network interface components may be configured by different parameters. These parameters may include control over interrupts (e.g., interrupt moderation settings and packets processed per interrupt), memory resources (e.g., transmit buffers and management structures, receive buffers and management structures), and other component operations (e.g., bus interface utilization modes).

The specific parameters may vary based on the network interface component being tuned. As an example, parameters of an Intel Pro Network Adapter may: control coalescing of packet portions into a smaller number of buffers (e.g., the number of coalesce buffers, the coalescing algorithm used, and limits on the size of buffers to be coalesced); identify resources for receiving packets (e.g., the number of receive buffers available to store packets, the number of receive descriptors identifying the receive buffers, the number of receive descriptors returned for reuse at a time, the minimum number of available receive descriptors to handle an arriving packet); identify resources for transmitting packets (e.g., the number of transmit descriptors); control delays between packet reception/transmission and interrupt signaling; control operation of a Deferred Procedure Call (DPC) loop (e.g., the number of iterations to perform a DPC loop at a time and the number of packets provided per DPC loop); parameters that control communication with a host (e.g., how many packets indicated to a protocol stack at a time, whether Memory Write and Invalidate (MWI) transactions are enabled, DMA priority between receive and transmit operations); control TCP operation (e.g., segmentation, maximum window size, number of Transport Control Blocks (TCBs) available); and so forth. Again, the parameters identified above are merely illustrative. A wide variety of other parameters may be used in the tuning process.

Though shown as residing locally, the parameter data 106 may reside at a remote site. Further, though shown as accessible to both the network interface card 102 and other host components 104, either the network interface component 102 or host processor(s) 104 may include tuning logic and/or have access to the parameter data 106. Potentially, the data 106 may be modified as the on-going performance of the component 102 is monitored.

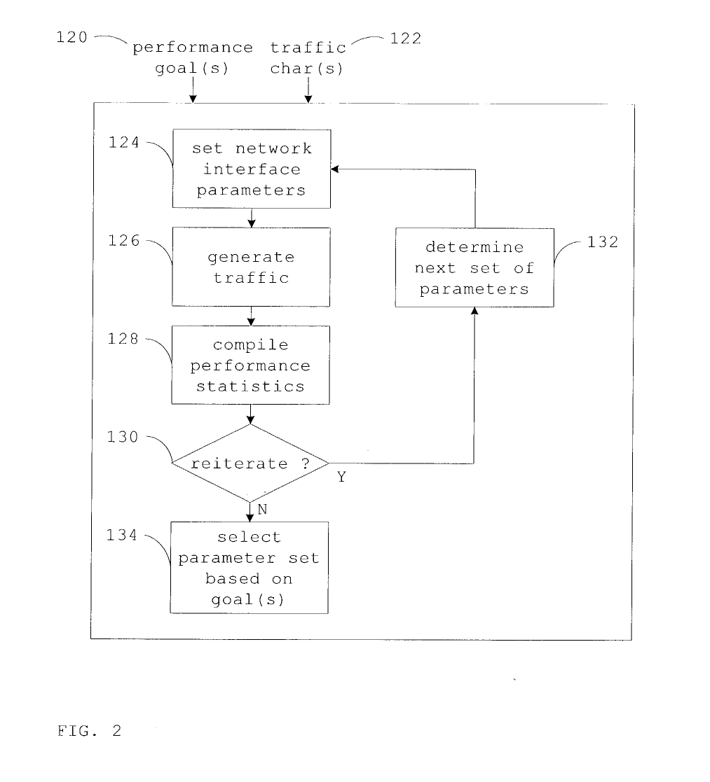

FIG. 2 depicts a sample process that can automatically generate and select parameter settings tailored to a particular environment (e.g., host system, network traffic, and/or network interface component characteristics). As shown, the process selects 134 a set of parameter values based on performance goals 120. The performance goals 120 can include a variety of metrics such as throughput (e.g., measured in bytes transmitted and received), memory usage, processor utilization, interrupts per second, and DPC loop count, among others.

As shown in FIG. 2, the process automatically applies 124 different sets of parameter values to a network interface component. For example, a first set of parameter values may set NumberReceiveBuffers to N and NumberTransmitBuffers to M, while a second set of parameters values sets NumberReceiveBuffers to N+1 and NumberTransmitBuffers to M-1.

Potentially, application of the values may require system rebooting and/or network interface component disabling and enabling. For each set of parameters, the process can cause generation 126 of network traffic having specified characteristics 122 (e.g., by invoking a batch file). Again, characteristics of the traffic can include the number and duration of connections, PDU size average and distribution, and so forth. As the interface handles the generated traffic, the process compiles 128 performance statistics. After monitoring the performance for the generated traffic, the process can determine 132 a new set of parameters to test.

To determine the parameter values to test, the process may use a “brute force” exhaustive evaluation of all different setting combinations. To speed testing, the process may instead automatically select or permit input of parameters to vary and acceptable discrete values or value ranges, thereby reducing the number of permutations to be explored. Alternately, the process may apply programmed heuristics (e.g., if CPU usage is too high, reduce interrupt signaling) or statistical design of experiments methodology.

Eventually, the process completes 130 testing of different sets of parameter values. For example, the process may finish testing parameter value permutations. Alternately, the process may gauge its progress toward an acceptable set of parameter settings, for example, by comparing a distance measurement between achieved and desired performance across tests. After testing completes 130, the process can select 134 a set of parameter values from those empirically tested. For example, the process can select the parameter settings closest to or furthest exceeding the performance goals 120.

The process shown in FIG. 2 has a wide variety of applications. For example, the process may be used to generate a table of settings (e.g., data 106 in FIG. 1) and/or determine factory settings that a component is shipped with. Alternately, the process may be an ongoing one. That is, a process may monitor component performance and search for better settings, for example, when performance degrades.

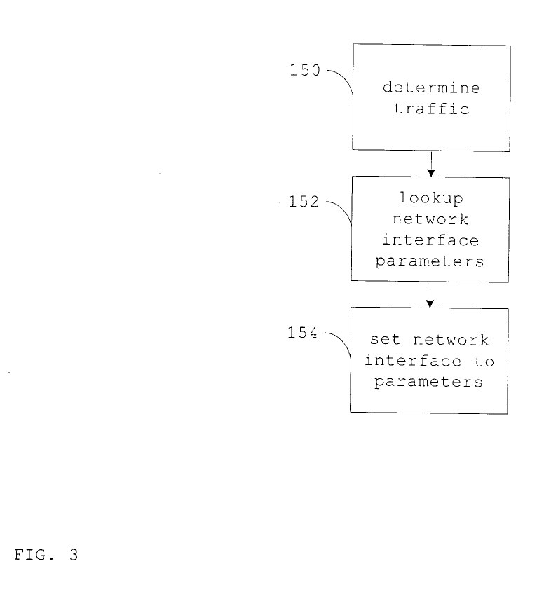

FIG. 3 depicts a process that configures a network interface component to parameter settings selected for particular network traffic/system characteristics. The process may statically provision the network interface component based on the anticipated environment. Alternately, the parameter values used may be dynamically selected as performance and traffic characteristics are monitored during “live” system 100 operation.

As shown, the process determines 150 network traffic handled by the network interface. For example, an operator may specify a particular type of traffic (e.g., by interacting with a user interface or data file). Alternately, the traffic may be determined automatically, for example, by monitoring characteristics of traffic being handled (e.g., protocol, application, incoming message size, outbound message size, incoming message volume, outbound message volume, and so forth). Based on the determined network traffic and/or system characteristics, the process can lookup 152 the parameters selected for such a setting. These parameters may then be applied 154 to the network interface.

The techniques described above can be used with a variety of network interface components other than a network interface card. For example, the techniques may be used to tune a Local Area Network (LAN) on Motherboard (LOM) component, LAN on chipset, and/or high-speed I/O controllers such as 1,10, or 40-Gigabit Ethernet medium access controller's (MACs), SONET, or Asynchronous Transfer Mode (ATM) Controllers. The techniques may also be used in a variety of settings. For example, the automated tool can be used in determining the default settings when a component is shipped. It can also be used to test boundary conditions and implementations of new parameter settings for validation purposes.

The techniques described above may be implemented in a wide variety of ways. For example, the logic may be included in a network interface component or may be performed by a device external to the component. Techniques described above may be implemented in firmware, hardware logic (e.g., an integrated circuit chip, Programmable Gate Array (PGA), Application Specific Integrated Circuit (ASIC), and so forth), software instructions, or some combination of these. For example, an implementation may feature software instructions disposed on a computer readable medium such as a magnetic storage, optical storage, or volatile or non-volatile memory device.

Other implementations and variations are within the scope of the following claims.

What is claimed is:

1. A method, comprising:
automatically applying different sets of parameter values to a network interface component, the parameters controlling operation of the network interface component;
storing performance data for the network interface component for the different sets of parameter values; and
selecting one of the different sets of parameters values based on the performance data.

2. The method of claim 1, wherein the sets of parameters comprise parameters governing at least one of the following: network interface component interrupts and memory used by the network interface component.

3. The method of claim 1, wherein the network interface component comprises at least one of the following: a Network Interface Card (NIC), a Local Area Network (LAN) on Motherboard (LOM), and a LAN on chipset component.

4. The method of claim 1, wherein the selecting comprises selecting according to at least one performance goal.

5. The method of claim 4, wherein the at least one performance goal comprises at least one of the following: a throughput goal and a processor usage goal.

6. The method of claim 1, further comprising causing generation of network traffic having at least one specified characteristic.

7. The method of claim 6, wherein the at least one specified characteristic comprises: size of incoming messages, size of outgoing messages, volume of incoming messages, and volume of outgoing messages.

8. The method of claim 6, wherein the at least one specified characteristic comprises a protocol of a layer in a network communication protocol stack.

9. The method of claim 8, wherein the layer comprises at least one of: an application layer, a network layer, and an Asynchronous Transfer Mode (ATM) adaptation layer.

10. The method of claim 8, wherein the protocol comprises at least one of the following: File Transfer Protocol (FTP), HyperText Transfer Protocol (HTTP), and Simple Mail Transfer Protocol (SMTP).

11. The method of claim 1, further comprising storing data for different sets of parameters for different respective network traffic.

12. The method of claim 11, wherein the storing data comprises storing data identifying at least one characteristic of the network traffic.

13. The method of claim 11, wherein the storing further comprises storing data identifying at least one system characteristic.

14. The method of claim 11, wherein the storing data comprises storing a network traffic identifier.

15. The method of claim 11, further comprising:
accessing the stored data for identified network traffic; and
applying the set of parameters associated with the identified network traffic to the network interface component.

16. A method, comprising:
selecting a set of parameters that control operation of a network interface component from within data storing different sets of network interface parameters for different network traffic; and
causing application of the set of network interface parameters to a network interface component.

17. The method of claim 16,
further comprising determining network traffic handled by the network interface component; and
wherein selecting a set of parameters comprises selecting based on the determining of network traffic.

18. The method of claim 17, wherein the determining of network traffic comprises determining at least one characteristic of the network traffic.

19. The method of claim 18, wherein the at least one characteristic comprises at least one of the following: protocol, application, size of incoming messages, size of outgoing messages, volume of incoming messages, and volume of outgoing messages.

20. The method of claim 17, wherein the determining network traffic comprises determining an identifier associated with one or more characteristics of the network traffic.

21. The method of claim 16, wherein the sets of parameters comprise parameters governing at least one of the following: network interface component interrupts and memory used by the network interface component.

22. The method of claim 16, further comprising:
applying different sets of parameters to the network interface component;
storing performance data for the network interface component for the different sets; and
selecting one of the sets of parameters for a type of network traffic based on the performance data.

23. The method of claim 22, wherein the selecting comprises selecting according to at least one performance goal.

24. The method of claim 22, further comprising causing generation of network traffic having at least one specified characteristic.

25. A system, comprising:
at least one host processor;
a network interface card, comprising:
at least one stored Ethernet address;
at least one physical layer (PHY) component;
at least one interface to a bus connecting the card to the at least one host processor; and
network interface card logic to perform operations on Ethernet frames; and
tuning logic to
select a set of parameters that control operation of the network interface card from within data storing different sets of network interface parameters for different network traffic; and
cause application of the set of network interface parameters to the network interface card.

26. The system of claim 25,
wherein the tuning logic further comprises logic to determine a type of network traffic handled by the network interface card; and
wherein the logic to select comprises logic to identify based on the determined type of network traffic.

27. The system of claim 25, further comprising logic to:
apply different sets of parameter values to the network interface component, the parameters controlling operation of the network interface component;
store performance data for the network interface component for the different sets of parameter values;
select one of the sets of parameter values based on the performance data; and
store the selected set of parameter values in the data storing different sets of network interface parameters for different network traffic.

28. The system of claim 27, further comprising logic to store at least one system characteristic in the data storing sets of network interface parameters for different network traffic.

29. The system of claim 27, wherein the tuning logic comprises at least one of the following: logic included within the network interface card and a computer program executing on a host processor coupled to the network interface card.

30. A computer program product, disposed on a computer readable medium, the program including instructions for causing a processor to:
automatically apply different sets of parameter values to a network interface component, the parameters controlling operation of the network interface component;
store performance data for the network interface component for the different sets of parameter values; and
select a one of the different sets of parameters values based on the performance data.

31. The computer program of claim 30, wherein the sets of parameters comprise parameters governing at least one of the following: network interface component interrupts and memory used by the network interface component.

32. The computer program of claim 30, wherein the instructions that cause the processor to select comprises instructions that cause the processor to select according to at least one performance goal.

33. The computer program of claim 32, further comprising instructions for causing the processor to cause generation of network traffic having at least one specified characteristic.

34. The computer program of claim 30, further comprising instructions for causing the processor to store data for different sets of parameters for different respective network traffic.

35. A computer program, disposed on a computer readable medium, the program including instructions for causing a processor to:
select a set of parameters that control operation of a network interface component from within data storing different sets of network interface parameters for different network traffic; and
cause application of the set of network interface parameters to a network interface component.

36. The computer program of claim 35,
further comprising instructions for causing the processor to determine network traffic handled by the network interface component; and
wherein the instructions that cause the processor to select data comprise instructions that cause the processor to select data based on the determining of network traffic.

37. The computer program of claim 35, wherein the instructions for causing the processor to determine network traffic comprise instructions for causing the processor to determine at least one characteristic of the network traffic.
